(19) United States
(12) Patent Application Publication
(10) Pub. No.: US 2003/0061480 A1
(43) Pub. Date: Mar. 27, 2003

(54) Method of authenticating IP paging requests as security mechanism, device and system therefor

(76) Inventors: Franck Le, Irving, TX (US); Stefano M. Faccin, Dallas, TX (US); Rajeev Koodli, Sunnyvale, CA (US); Jari T. Malinen, Mountain View, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/237,024

(22) Filed: Sep. 9, 2002

Related U.S. Application Data
(60) Provisional application No. 60/322,158, filed on Sep. 14, 2001.

(51) Int. Cl. H04L 9/00

(52) U.S. Cl. 713/153

(57) ABSTRACT

A method of authenticating a paging request within an IP environment, said environment comprising a paging area having a plurality of access router (PAR, AR) and at least one mobile node (MN), said method comprising the steps of: sharing a session security key (K) between said mobile node (MN) and an access router (PAR) to which said mobile node (MN) has been previously attached to; receiving (S1) a packet incoming for said mobile node (MN) by said previous access router (PAR), wherein said mobile node (MN) is in a dormant mode; submitting (S2) a paging request to all other access routers (AR) of said paging area by said previous access router (PAR) about the packet which came in, thereby also distributing said session security key (K); generating (S3) authentication parameters according to a predetermined process by an access router (AR) to which said mobile node (MN) is currently attached to; submitting (S4) said paging request from said access router (AR) to said mobile node (MN) including said authentication parameters; verifying (S5) the validity of said request by said mobile node (MN), wherein said authentication parameters are processed according to said predetermined process; and submitting (S6) a paging response from said mobile node (MN) to said access router (AR), wherein said response authenticates said paging request.

The present application hereby incorporates by the provisional application No. 60/322,158 filed on Sep. 14, 2001, with the United States Patent and Trademark Office and the benefit thereof is claimed herewith.

### FIELD OF THE INVENTION

The present invention relates a security mechanism for IP paging areas, within which, in particular, corresponding IP paging requests for protection against e.g. anti-replay attacks are authenticated. Moreover, the present invention relates to a paging functionality device and a system utilizing the method and the device, respectively. In the present invention, an introduction of paging at the third level (Internet Protocol level) of Internet Protocol (hereinafter: IP) mobile networks is considered.

### RELATED BACKGROUND ART

The Internet Engineering Task Force (hereinafter: IETF) has been working for some time on IP paging and several solutions are being developed. In order for IETF solutions to be adopted for future IP mobile networks to which current cellular networks are evolving, some mechanisms/solutions need to be introduced to optimize the security of IP paging solutions, increase the adoptability of such solutions and to allow for new service scenarios.

The current reference model for paging according to the IETF is depicted in FIG. 1. This high level model defines a functional model where no allocation to physical nodes is present. That is, the logic of paging is defined, not the protocols. The reference signs designate the time when a respective action takes place. In detail, at t0 packets come in at the dormant mobility agent DMA. The dormant mobility agent DMA knows the current “latest” point of contact for a mobile node, i.e. there is no current IP address known for the mobile node “below” the dormant mobility agent DMA. At t1, the dormant mobility agent DMA realizes that the mobile node is dormant. Thus, a page request message is sent to the tracking agent TA at time t2, wherein the tracking TA is informed by the mobile node of the current paging area. That is, in a continuous operation the mobile node keeps the tracking agent TA up to date with the current IP paging area. As a result, the tracking agent TA sends a page command message at t3 to the paging agent PA which is able to perform a level three (L3) paging (L3 with respect to IP) in the paging area. Consequently, at t4 such L3 paging message is sent to all access routers in the IP paging area where the mobile node is. In turn, these access routers convey the L3 paging message to all mobile nodes in the respective area of an access router. By receiving such message, the mobile node “wakes up” and replays to page at t6. Then, the mobile node performs a needed mobility to become reachable by the IP traffic.

P. Mutaf and C. Castellucia disclosed in “IP Paging Security Requirements”, Internet draft, Internet Engineering Task Force, May 2001, the demand that the IP paging protocol must have a strong security mechanism to prevent all the identified threats that may affect the IP paging protocol performance. Without an adequate security model, intruders could even prevent IP paging from reaching its goals and, on the contrary, to result in the opposite effects by different attacks: the signaling volume may become so important that the network gets overloaded and communications can not be established anymore; and from the mobile node point of view; its battery lifetime may expire earlier than expected thus becoming unreachable.

Further, “Idle mode handover support in IPv6 networks” by Rajeev Koodli and Jari T. Malinen, Internet draft, Internet Engineering Task Force, July 2001, discloses the generation of a Local Challenge by an access router for user authentication as well as the computation of some user authentication data based on the Local Challenge, and a session key is described. Further, the use of a multicast address “all access routers multicast group” by a previous access router to send a paging request is described. All access routers within a paging area are members of this multicast group and thus receive the paging request packet.

### SUMMARY OF THE INVENTION

It is an object of the present invention to overcome the above problems of the prior art, and to provide a support of security mechanisms associated with IP level paging areas in IP mobile networks.

According to the present invention, the object is solved by providing a method of authenticating a paging request within an IP environment, said environment comprising a paging area having a plurality of access router and at least one mobile node, said method comprising the steps of: sharing a session security key between said mobile node and an access router to which said mobile node has been previously attached to; receiving a packet incoming for said mobile node by said previous access router, wherein said mobile node is in a dormant mode; submitting a paging request to all other access routers of said paging area by said previous access router about the packet which came in, thereby also distributing said session security key; generating authentication parameters according to a predetermined process by an access router to which said mobile node is currently attached to; submitting said paging request from said access router to said mobile node including said authentication parameters; verifying the validity of said request by said mobile node, wherein said authentication parameters are processed according to said predetermined process; and submitting a paging response from said mobile node to said access router, wherein said response authenticates said paging request.

According to the present invention, the object is further solved by providing a method of authenticating a user of a mobile node within an IP environment, said environment comprising a paging area having a plurality of access router and at least one mobile node, wherein said method comprising the steps of: executing the method of authenticating a paging request within an IP environment according to the present invention; generating a local challenge for user authentication by said access router; computing user authentication data on the basis of said local challenge and said session security key by said mobile node; submitting said user authentication data from said mobile node to said access router; and verifying the validity of said mobile node by said access router according to said predetermined process.

According to the present invention, the object is still further solved by providing system for authenticating an IP paging request, said system comprising: a paging area having a plurality of access router devices, wherein said access router devices include means adapted to keep a session security key, means adapted to receive an incoming packet, means adapted to generate authentication parameters according to a predetermined process, and means adapted to submit a paging request, said session security key and said authentication parameters; and at least one mobile node, wherein said mobile node includes means adapted to verify the validity of said paging request including processing means for processing said authentication parameters according to said predetermined process, and means adapted to submit an authenticating paging response.

According to a preferred embodiment of the present inventions said predetermined process includes the steps of generating a random number by said access router; creating a sequence number which is user and router specific and which must only increase in value; computing, by said access router, a token based on at least said random number, said sequence number, said session security key and a common algorithm shared between said access router and said mobile node; encrypting said sequence number by using said session security key by said access router; sending said token, said random number and said encrypted sequence number to said mobile node; and deciphering said sequence number by said mobile node by using said session security key; wherein said verifying step is executed by verifying the validity of said sequence number in that it must always increase in value, thus ensuring the freshness of said paging request, verifying said token thus ensuring the validity of the paging request originating network, and keeping said sequence number for future verifications.

According to the preferred embodiment of the present invention, the system according to the present invention is adapted to perform this method.

A main advantage of the method according to the present invention is that a security mechanism is provided which does not need additional messages.

These and other features, aspects, and advantages of the present invention will become more readily apparent with reference to the following description of the preferred embodiments thereof which are to be taken in conjunction with the accompanying drawings.

It is to be understood, however, that the drawings are designed solely for the purposes of illustration and not as a definition of the limits of the invention, for which reference should be made to the appended claims.

### BRIEF DESCRIPTION OF THE DRAWINGS

FIG. 1 is illustrative of the known IETF functional model for paging.

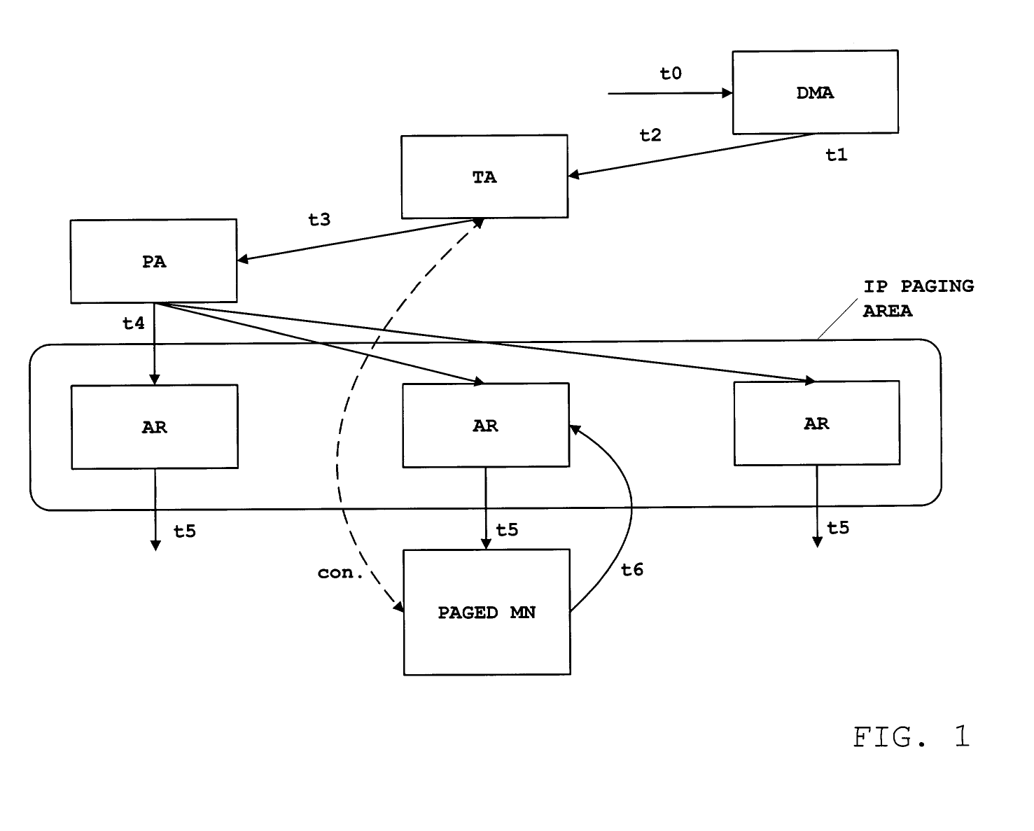

FIG. 2 shows the system and method according to the present invention.

### DETAILED DESCRIPTION OF THE PREFERRED EMBODIMENTS

Hereinafter, a system for providing intelligent and secure control of data over a mobile communications network as a preferred embodiment of the present invention is described.

The security mechanism according to the present invention provides network authentication and anti replay attacks to the IP paging requests as required by Mutaf et Castellucia, “IP paging Security Requirements”, Internet draft, Internet Engineering Task Force, May 2001. Without such protection an intruder can perform many different types of attacks that may affect the performance of the IP paging protocol. As an example, the intruder may unnecessarily wake up the mobile node preventing him to go to dormant mode, and consumes its battery quickly, making the mobile node becoming inaccessible.

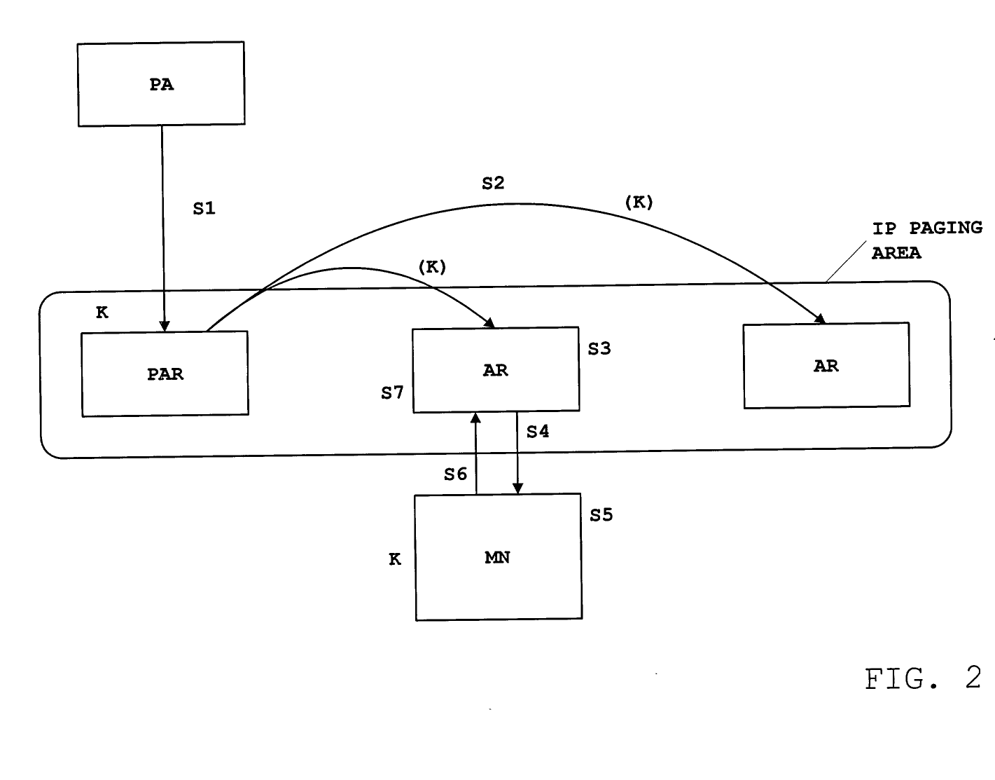

By referring to FIG. 2, the preferred embodiment of the present invention is described below.

When an incoming packet (step S1) destined to a dormant mobile node MN arrives to the previous access router PAR, this latter one pages the different access routers AR of the paging area in a step S2.

As described by Koodli et Malinen “Idle Mode Handover Support in IPv6 Networks”, Internet draft, Internet Engineering Task Force, July 2001, the previous access router PAR uses a well known multicast address, the “all access routers multicast group”, to send the paging request. All the access routers AR within the paging area are members of this multicast group, and thus receive the paging request packet.

The paging message also contains the session security key K shared between the mobile node MN and the previous access router PAR. This session security key K is used for network authentication and for user authentication.

In a step S3, the access router AR generates a random number R, and creates a sequence number N1. This sequence number N1 is user and router specific and must only increase in value. The access router AR computes a token based at least on the random number R, the sequence number N1, the session security key K and a common algorithm shared with the mobile node MN (so to speak token (N1, R, K)). The access router AR encrypts the sequence number N1 using the session security key K, and the encrypted sequence number N1, and sends all the token (N1, R, K), the random number R and the encrypted sequence number N1 to the mobile node MN for network authentication (Step S4). The access router AR also generates a Local Challenge for user authentication as described by Koodli et Malinen, “Idle Mode Handover Support in IPv6 Networks”, Internet draft, Internet Engineering Task Force, July 2001.

On receipt of the IP paging request, in a step S5, the mobile node MN deciphers the sequence number N1 by adopting the session security key K on the encrypted sequence number N1. As stated above, the sequence number N1 must always increase in value which ensures the freshness of a message.

Further, the mobile node MN also verifies the token. The mobile node MN can thus make sure that the IP paging request is coming from the valid network.

Moreover, the mobile node MN keeps the sequence number N1 for future verifications.

The mobile node MN also computes some user authentication data based on the Local Challenge and the session security key K, these data may optionally have to be protected for anti-replay attacks.

After sending (Step S6) the mobile node's response to the access router AR, it can thus verify the validity of the responding mobile node MN in a step S7.

Thus, what is described above may be summarized as providing a method of authenticating a paging request within an IP environment, said environment comprising a paging area having a plurality of access router PAR, AR and at least one mobile node MN, said method comprising the steps of: sharing a session security key K between said mobile node MN and an access router PAR to which said mobile node MN has been previously attached to; receiving a packet incoming for said mobile node MN by said previous access router PAR, wherein said mobile node MN is in a dormant mode; submitting a paging request to all other access routers AR of said paging area by said previous access router PAR about the packet which came in, thereby also distributing said session security key K; generating authentication parameters according to a predetermined process by an access router AR to which said mobile node MN is currently attached to; submitting said paging request from said access router AR to said mobile node MN including said authentication parameters; verifying the validity of said request by said mobile node MN, wherein said authentication parameters are processed according to said predetermined process; and submitting a paging response from said mobile node MN to said access router AR, wherein said response authenticates said paging request.

Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

1. A method of authenticating a paging request within an IP environment, said environment comprising a paging area having a plurality of access router (PAR, AR) and at least one mobile node (MN), said method comprising the steps of:
sharing a session security key (K) between said mobile node (MN) and an access router (PAR) to which said mobile node (MN) has been previously attached to;
receiving (S1) a packet incoming for said mobile node (MN) by said previous access router (PAR), wherein said mobile node (MN) is in a dormant mode;
submitting (S2) a paging request to all other access routers (AR) of said paging area by said previous access router (PAR) about the packet which came in, thereby also distributing said session security key (K);
generating (S3) authentication parameters according to a predetermined process by an access router (AR) to which said mobile node (MN) is currently attached to;
submitting (S4) said paging request from said access router (AR) to said mobile node (MN) including said authentication parameters;
verifying (S5) the validity of said request by said mobile node (MN), wherein said authentication parameters are processed according to said predetermined process; and
submitting (S6) a paging response from said mobile node (MN) to said access router (AR), wherein said response authenticates said paging request.

2. A method according to claim 1, wherein said predetermined process includes the steps of
generating a random number (R) by said access router (AR);
creating a sequence number (N1) which is user and router specific and which must only increase in value;
computing, by said access router (AR), a token based on at least said random number (R), said sequence number (N1), said session security key (K) and a common algorithm shared between said access router (AR) and said mobile node (MN);
encrypting said sequence number (N1) by using said session security key (K) by said access router (AR);
sending said token, said random number (R) and said encrypted sequence number (N1) to said mobile node (MN); and
deciphering said sequence number (N1) by said mobile node (MN) by using said session security key (K);
wherein said verifying step (S5) is executed by verifying the validity of said sequence number (N1) in that it must always increase in value, thus ensuring the freshness of said paging request, verifying said token thus ensuring the validity of the paging request originating network, and keeping said sequence number (N1) for future verifications.

3. A method of authenticating a user of a mobile node within an IP environment, said environment comprising a paging area having a plurality of access router (PAR, AR) and at least one mobile node (MN), wherein said method comprising the steps of:
executing the method according to claim 1;
generating (S3, S4) a local challenge for user authentication by said access router (AR);
computing (S5) user authentication data on the basis of said local challenge and said session security key (K) by said mobile node (MN);
submitting (S6) said user authentication data from said mobile node (MN) to said access router (AR); and
verifying (S7) the validity of said mobile node (MN) by said access router (AR) according to said predetermined process.

4. A method according to claim 3, wherein said predetermined process includes the steps of
generating a random number (R) by said access router (AR);
creating a sequence number (N1) which is user and router specific and which must only increase in value;
computing, by said access router (AR), a token based on at least said random number (R), said sequence number (N1), said session security key (K) and a common algorithm shared between said access router (AR) and said mobile node (MN);
encrypting said sequence number (N1) by using said session security key (K) by said access router (AR);
sending said token, said random number (R) and said encrypted sequence number (N1) to said mobile node (MN); and
deciphering said sequence number (N1) by said mobile node (MN) by using said session security key (K);
wherein said verifying step (S5) is executed by verifying the validity of said sequence number (N1) in that it must always increase in value, thus ensuring the freshness of said paging request, verifying said token thus ensuring the validity of the paging request originating network, and keeping said sequence number (N1) for future verifications.

5. A system for authenticating an IP paging request, said system comprising:
a paging area having a plurality of access router devices (PAR, AR), wherein said access router devices include means adapted to keep a session security key (K), means adapted to receive an incoming packet, means adapted to generate authentication parameters according to a predetermined process, and means adapted to submit a paging request, said session security key (K) and said authentication parameters; and
at least one mobile node (MN), wherein said mobile node includes means adapted to verify the validity of said paging request including processing means for processing said authentication parameters according to said predetermined process, and means adapted to submit an authenticating paging response.

6. A system according to claim 5, said system being adapted to perform the method according to claim 2.

7. A system according to claim 5, said system being adapted to perform the method according to claim 4.
